(19) United States
(12) Patent Application Publication
(10) Pub. No.: US 2009/0287544 A1
(43) Pub. Date: Nov. 19, 2009

(54) Customer managed restaurant information system

(76) Inventor: Seth L. Neubardt, Mamaroneck, NY (US)

Correspondence Address: LAW OFFICE OF LEO ZUCKER, 2591 Duning Drive, PO BOX 1177, Yorktown Heights, NY, 10598, US

(21) Appl. No.: 12/454,259

(22) Filed: May 14, 2009

Related U.S. Application Data
(60) Provisional application No. 61/127,564, filed on May 14, 2008.

(51) Int. Cl. G06Q 50/00; G06Q 10/00; G06Q 30/00

(52) U.S. Cl. 705/10; 705/21; 705/18

(57) ABSTRACT

A restaurant information system includes a point-of-sale (POS) device constructed and arranged for identifying a customer at a restaurant, an amount owed for food or other items purchased at the restaurant, a financial services provider, and a restaurant customer service of which the customer is a member. A network server is associated with the restaurant customer service, and is configured to access a personal customer file created by the customer. The POS device is configured to prompt and receive a customer entry including a review or other comments concerning the restaurant, and to address the customer entry to the second network server for writing in the customer's personal file. The network server may also be configured to compile a searchable database reflecting customer entries made in a number of different customer files.

### CROSS REFERENCE TO RELATED APPLICATION

This application claims priority under 35 U.S.C. §119(e) of co-pending U.S. Provisional Patent Application No. 61/127,564 filed May 14, 2008, entitled Customer Managed Restaurant Information System, and incorporated by reference in its entirety herein.

### BACKGROUND OF THE INVENTION

1. Field of the Invention

The present invention relates generally to information systems and networks, and particularly to a system for disseminating information regarding restaurants among existing and potential customers.

2. Discussion of the Known Art

Systems have been disclosed for the purpose of allowing restaurant proprietors to obtain and manage responses to surveys and other sensitive customer-related data. Such systems often entice customers by offering them rewards if they respond to survey questions presented on a point-of-sale (POS) device when paying their tab. See, e.g., U.S. Pat. Application Pub. No. 2005/0043996 (Feb. 24, 2005) disclosing a system that collects and stores responses to a post dining survey which the customer enters when paying his or her check. The publication also states that the customer may log into a special web portal that provides a list of restaurants based on a set of preferences, but does not explain how or by whom the list or the preferences are compiled.

U.S. Pat. Application Pub. No. 2007/0214052 (Sep. 13, 2007) discloses a “consumer driven” system for hospitality applications, using telecommunication technology integration. The system is described as allowing customers to obtain restaurant-related information including blogs, and to make reservations at their “old” restaurant with seating and food selections. The publication does not detail how the system is actually constructed in order to carry out the mentioned functionality, however. See also, U.S. Pat. No. 7,281,652 (Oct. 16, 2007), describing a point-of-sale system having a customer information entry component for providing customer input to a database, wherein the database is supported by a financial service provider which implements the customer's payment at the point-of-sale, and U.S. Pat. Application Pub. No. 2002/0107747 (Aug. 8, 2002) which relates to a system that enables customers to find and select restaurants.

### SUMMARY OF THE INVENTION

According to the invention, a customer managed restaurant information system includes a point-of-sale (POS) device constructed and arranged for identifying a customer at a restaurant, a monetary amount owed by the customer for food or other items purchased by the customer at the restaurant, an associated financial services provider, and a restaurant customer service of which the customer is a member. A first network server is associated with the financial services provider, and a second network server is associated with the restaurant customer service. The second network server is configured to access a personal customer file created by the customer. The POS device is configured to prompt and to receive a customer entry including a review or other comments concerning the restaurant, and to address the customer entry to the second network server for writing in the personal customer file.

For a better understanding of the invention, reference is made to the following description taken in conjunction with the accompanying drawing and the appended claims.

### BRIEF DESCRIPTION OF THE DRAWING

In the drawing:

FIG. 1 is a block diagram of a first embodiment of a customer managed restaurant system according to the invention; and

FIG. 2 is a block diagram of a second embodiment of a customer managed restaurant system according to the invention.

### DETAILED DESCRIPTION OF THE INVENTION

The inventive system allows a restaurant patron or customer to create a personal file that is accessible only by the customer and others specifically designated by the customer, and to access the file and enter rating or other information concerning a restaurant when paying their check via a point-of-sale (POS) or other financial transaction device at the restaurant. In addition, if a customer contemplates returning to a certain restaurant for which they previously entered comments in their file, they can first access their file and review the comments before returning or calling the restaurant for a reservation.

In one embodiment, individual customer files are administered by an on-line or Internet-accessible restaurant customer service that may be identified by a domain name such as, for example, “MyCheckPlease.com”. A number of restaurant patrons may therefore become members of the service and elect to share their individual files with other service members and, if desired, with selected restaurant proprietors as well.

The POS device may include, for example, a magnetic stripe card reader that is constructed and arranged in a known manner for reading a patron's credit or debit card, and for completing a financial transaction by linking with a financial services provider associated with the card. The POS device may also be hard wired conventionally to a public switched telephone network (PSTN), or constructed in a known manner to operate wirelessly through a network access point provided at the restaurant premises.

In accordance with the invention, the POS device is also configured to access a personal file that has previously been created by the patron once the transaction is approved, for example, by (i) linking the patron to the mentioned restaurant customer service, (ii) prompting the patron to enter rating or other information concerning the restaurant, and (iii) inquiring whether or not any of the information entered by the patron may be shared with other members of the service and/or with the restaurant proprietor.

The POS device may be constructed and arranged to operate in a conventional manner insofar as the device recognizes a given restaurant customer either from a swipe of the customer's charge card, and/or from a personal identification number (PIN) entered by the customer. Once a positive identification is made, the POS device processes the transaction using, for example, one of two protocols.

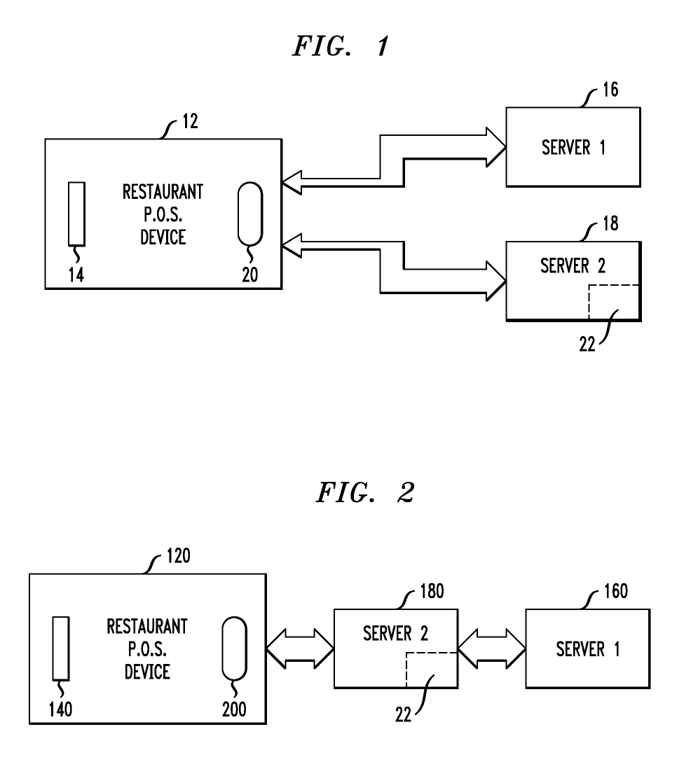

FIG. 1 represents Example One below. In Example One, the POS device addresses a first message containing only the corresponding transaction data to the customer's financial services provider, and a second message containing only the customer's restaurant rating information is addressed to and entered into the customer's personal file maintained by the restaurant customer service.

FIG. 2 represents Example Two below. In Example Two, the transaction data and the rating information are combined in one message that is addressed to a server maintained by the restaurant customer service which, in turn, forwards the transaction data to the customer's financial services provider and reports back to the POS device. The POS device then accesses the customer's personal file and prompts the customer to add restaurant specific information or data in his or her file at that time. Alternatively, in lieu of a dedicated POS device, either protocol may be carried out by a customer's own wireless cell phone if, for example, the phone is a so-called currently available “smart” phone capable of being programmed and configured accordingly.

### EXAMPLE ONE

### FIG. 1

1. Customer A is presented with a restaurant check, and the restaurant cashier swipes customer A's Visa® credit card through a POS device 12 that has been configured according to the invention.

2. The POS device 12 recognizes the card, the amount owed is entered via an input keypad 14, and the device 12 addresses the corresponding financial transaction data (customer A's identity, amount charged, etc.) via a secure link to a server 16 maintained and/or operated by Visa.

3. Once the transaction is approved, the server 16 generates a receipt for customer A's signature, and sends an acknowledgment message to the POS device 12.

4. Upon receipt of the acknowledgment message, the POS device 12 addresses another server 18 maintained and/or operated by the restaurant customer service. Customer A's personal file is identified by way of, e.g., his or her name and card number as were entered in the POS device 12, and access to customer A's file is provided by the server 18. A display 20 associated with the POS device 12 then prompts customer A to enter a review or other comments concerning the restaurant into his or her file by way of the keypad 14 on the POS device 12.

### EXAMPLE TWO

### FIG. 2

1. Customer B is presented with a restaurant check, and the restaurant cashier swipes customer B's Amex® credit card through a POS device 120 that has been configured according to the invention.

2. The POS device 120 recognizes the card, the amount owed is entered via an input keyboard 140, and the device 120 addresses the corresponding financial transaction data (customer B's identity, amount charged, etc.) via a secure link to a server 180 maintained and/or operated by the restaurant customer service which, in turn, forwards the financial transaction data via a secure link to another server 160 maintained and/or operated by Amex.

3. Once the transaction is approved, server 160 sends an acknowledgment message and a receipt for customer B's signature to the restaurant customer service server 180 which, in turn, forwards the receipt to the POS device 120.

4. Upon receipt of the acknowledgment message, the restaurant customer service server 180 also identifies customer B's personal file by way of, e.g., his or her name and Amex card number, and access to customer B's file is also provided via the server 180. A display 200 associated with the POS device 120 then prompts customer B to add a review or other comments concerning the restaurant into his or her file by using the keypad 200 on the POS device 120.

In either Example One or Example Two, restaurant customers are afforded an opportunity to use a POS transaction device not only to pay for their meal purchase, but also to enter a review or other comments into their personal files to reflect their purchasing experience.

When members of the restaurant customer service elect to share information entered in their files based on their personal experiences with other service members, a database 22 reflecting combined member ratings for a number of restaurants may therefore be compiled by the customer service server 18 or 180, using known database applications. The database 22 may also be configured in a known manner to be searchable by one or more of food category, geographic location, price and the like, and made accessible exclusively to members of the service for their own use and benefit.

For members having smart phones or other wireless devices that provide Internet connectivity, the inventive system allows a member who arrives at an unfamiliar destination to locate one or more restaurants whose menus and prices satisfy the member's needs. For example, upon arriving in Boston, a qualified member may log onto the customer service and enter a “Search for Restaurant” command. The member is then presented with a list of preferences from which he or she can select food type(s), food quality, quality of service, typical seating availability for breakfast, lunch or dinner; prices and the like. The member's location in Boston is then entered by the member or, if the member's wireless device is GPS enabled, the location may be transmitted seamlessly by the device. A host server of the restaurant customer service, e.g., the server 18 or 180 in FIGS. 1 and 2, may then be configured to compare the member's location and selected preferences with corresponding information from the member compiled database, and/or from other sources including restaurants affiliated with the service.

The host server then provides the traveling member with search results in which, for example, the top ten restaurants in or near Boston matching the member's preferences are ordered, together with an address and telephone number for each restaurant. If the member's wireless device is GPS enabled, a map of Boston may also be displayed on the device with markers superimposed at the restaurant locations, and a numeral associated with the marker indicating the relative order of the restaurant with respect to the member's preferences.

Once the member chooses a restaurant that best suits him or her, the inventive system may be configured in a known manner to provide the member an option of having a reservation request transmitted to the restaurant for immediate acknowledgment. This option may, if desired, apply only to those restaurants that have become affiliated with or approved by the customer service. The member may also be prompted to enter one or more alternate restaurants in the event the first reservation choice can not be obtained or confirmed.

While the foregoing represents preferred embodiments of the invention, it will be understood by those skilled in the art that various modifications and changes may be made without departing from the spirit and scope of the invention, and that the invention includes all such modifications and changes as are within the bounds of the following claims.

I claim:

1. A customer managed restaurant information system, comprising:
a point-of-sale (POS) device constructed and arranged for identifying a customer at a restaurant, a monetary amount owed by the customer for food or other items purchased by the customer at the restaurant, an associated financial services provider, and a restaurant customer service of which the customer is a member;
a first network server associated with the financial services provider; and
a second network server associated with the restaurant customer service, wherein-the second network server is configured to access a personal customer file created by the customer; and
wherein the POS device is configured to prompt and to receive a customer entry including a review or other comments concerning the restaurant, and to address the customer entry to the second network server for writing in the personal customer file.

2. A restaurant information system according to claim 1, wherein the POS device is constructed and arranged to address financial transaction data concerning the customer's purchase to the first network server.

3. The system of claim 2, wherein the first network server is configured to address an acknowledgment message representing an approval of the financial transaction data to the POS device.

4. The system of claim 3, wherein the POS device is constructed and arranged to address the customer entry to the second network server upon receiving the acknowledgment message from the first network server.

5. A restaurant information system according to claim 1, wherein the POS device is constructed and arranged to address financial transaction data concerning the customer's purchase to the second network server.

6. The system of claim 5, wherein the second network server is configured to forward the financial transaction data to the first network server.

7. The system of claim 6, wherein the first network server is configured to address an acknowledgment message representing an approval of the financial transaction data to the second network server.

8. The system of claim 7, wherein the second network server is configured to enable the POS device to address the customer entry to the second network server when the second network server receives the acknowledgment message from the first network server.

9. A restaurant information system according to claim 1, wherein the second network server is configured to compile a database corresponding to entries in a number of different customer files.

10. The system of claim 9, wherein the database reflects combined customer ratings for a number of restaurants, and is configured to be searchable by one or more of food category, geographic location, and price.

11. The system of claim 10, wherein the second network server is configured to allow access to the database exclusively by members of the restaurant customer service.

12. A restaurant information system according to claim 1, wherein the second network server is constructed and arranged to be accessible via the Internet.

13. A restaurant information system according to claim 1, wherein the POS device comprises a cellular telephone.
